(19) United States
(12) Patent Application Publication
(10) Pub. No.: US 2017/0225713 A1
(43) Pub. Date: Aug. 10, 2017

(54) MOTOR VEHICLE BODY ARRANGEMENT DESIGNED IN PARTICULAR FOR A COLLISION WITH LITTLE OVERLAP

(71) Applicant: CONSTELLIUM SINGEN GMBH, Singen (DE)

(72) Inventors: Martin BRANDHUBER, Unterföhring (DE); Marike SEUFERT, Graz (AT); Thomas BÖSCHL, München (DE); Johannes HASSELBACH, München (DE); Andreas HUTH, München (DE); Egon MAYR, Rudelzhausen (DE); Bart PETERS WEEM, Hallbergmoos (DE); Matthias KUTSCHER, Konstanz (DE)

(73) Assignee: CONSTELLIUM SINGEN GMBH, Singen (DE)

(21) Appl. No.: 15/502,848

(22) PCT Filed: Aug. 19, 2015
(86) PCT No.: PCT/EP2015/069036

§ 371 Date: Feb. 9, 2017

(30) Foreign Application Priority Data
Aug. 20, 2014 (DE) 10 2014 216 478.8

(51) Int. Cl. B62D 21/15; B60R 19/03; B60R 19/02

(52) U.S. Cl. CPC B62D 21/152; B60R 19/023; B60R 19/03

(57) ABSTRACT

A body arrangement having a longitudinal member arrangement, a bumper cross-member, and a support element. The bumper cross-member is fastened to one end of the longitudinal support and an end portion of the bumper cross-member projects in the transverse direction beyond the longitudinal support. The support element is fastened to the end portion of the bumper cross-member and extends over a predetermined length towards the rear in the longitudinal direction of the vehicle. The support element preferably extends substantially parallel to the longitudinal member arrangement. The support element is disposed or designed with a predetermined spacing with respect to the longitudinal member arrangement. The support element supports the end portion of the longitudinal member arrangement in the event of a deformation of the end portion of the bumper cross-member following a frontal collision of the vehicle, in particular a frontal collision with little overlap.

The present invention relates to a body arrangement for a motor vehicle, which is designed in particular for a collision with little overlap, comprising a longitudinal member arrangement and a bumper cross-member which is fastened to one end of the longitudinal member arrangement.

In the event of a frontal collision of a motor vehicle with a collision opponent, wherein the motor vehicle only overlaps a little with the collision partner, there are special requirements for a body in a front end region of the motor vehicle.

A known motor vehicle has in particular a left longitudinal support and a right longitudinal support, which in the case of a motor vehicle with a front-mounted engine may also be referred to as engine supports, on the front end of which a bumper cross-member is disposed. In addition between the actual longitudinal supports and the bumper cross-members a so-called crash element or deformation element can be disposed, which is designed to be replaceable and is intended to protect the longitudinal support against irreversible damage in the event of low-speed collisions. The bumper cross-member projects over the left and right longitudinal supports outwards in the transverse direction in the usual way.

In the frontal collision with little overlap the collision opponent impacts in particular outside one of the two longitudinal supports on the bumper cross-member and deforms this latter in the direction of the corresponding longitudinal support.

In this connection there are already considerations in the prior art as to how a transverse impulse between the motor vehicle and the collision opponent can be generated so that they can be pushed away from one another and thus the collision energy to be absorbed by the motor vehicle is decreased. Furthermore there are considerations aiming to better reduce collision energy in the event of such a frontal collision with little overlap. DE 102011053158 B4 for example shows a bumper system with a deformation element which is disposed between the longitudinal support or a crashbox and the transverse support. The deformation element bears with its inner wall substantially flush against the longitudinal support and the crashbox and is also connected in a flush manner to the bumper cross-member. In the event of a frontal collision with little overlap the end portion of the bumper cross-member as well as the deformation element supported on the longitudinal support or the crashbox is deformed. As a result the parties to the accident are pushed away from one another by the deformation. On the other hand, collision energy is absorbed by the plastic deformation.

Due to the plastic deformation of the deformation element an input of energy into the longitudinal support is comparatively low. Furthermore for a conventional collision with full overlap, in particular in the event of a collision with full overlap at low speed, in which only the crashbox is intended to be deformed, the described arrangement is disadvantageous due to the engagement between a deforming crashbox and the deformation element.

Therefore the object of the present invention is to create a body arrangement for a motor vehicle, wherein in a frontal collision of the motor vehicle with little overlap sufficient energy can be introduced into the longitudinal member arrangement by means of a simple, light and yet effective solution, and a deformation of a front portion of the longitudinal member arrangement is better enabled in the event of collisions at low speed.

This object is achieved by a body arrangement for a motor vehicle with the features of claim 1. Advantageous modifications are set out in the dependent claims.

A body arrangement according to the invention for a motor vehicle has a longitudinal member arrangement, a bumper cross-member and a support element. The bumper cross-member is fastened to one end of the longitudinal support and an end portion of the bumper cross-member projects in the transverse direction beyond the longitudinal support. The support element is fastened to the end portion of the bumper cross-member and extends over a predetermined length towards the rear in the longitudinal direction of the vehicle. The support element preferably extends substantially parallel to the longitudinal member arrangement. The support element is disposed or designed with a predetermined spacing with respect to the longitudinal member arrangement. Furthermore the support element according to the invention is designed in such a way that in the event of a deformation of the end portion of the bumper cross-member following a frontal collision of the vehicle, in particular a frontal collision with little overlap, said support element supports the end portion on the longitudinal member arrangement as the collision proceeds. In this case, i.e. due to the support, a further deformation of the end portion in the direction of the longitudinal member arrangement is inhibited. The supporting element is made from a plastic, preferably a fibre-reinforced plastic or fibre-reinforced plastic composite material.

Due to the spacing according to the invention of the support element from the longitudinal member arrangement it is possible that in the event of a frontal collision with a large overlap, in particular with a full overlap, the longitudinal member arrangement can deform sufficiently without engaging with the support element or being influenced in its deformation by the support element. Furthermore, in this way in the event of a collision with large or full overlap the support element can be displaced along the longitudinal member arrangement without engaging with the longitudinal member arrangement. Conversely in the event of a frontal collision with little overlap the support element can be sufficiently supported on the longitudinal member arrangement, so that a required transverse impulse towards the parties to the accident is generated and these are pushed away from one another, so that as a whole less collision energy must be dissipated by the motor vehicle, in particular the body arrangement. Furthermore the spacing of the support element from the longitudinal member arrangement enables at least a certain deformation of the end portion of the bumper cross-member at the start of the frontal collision with little overlap, so that in this way better sliding of the parties to the accident on one another is possible. Because the supporting element is made from plastic it can be produced in a sufficiently lightweight and cost-effective manner. By a reinforcement of the plastic with fibres it is possible to further increase the strength of the supporting element or to further reduce the weight of the supporting element whilst retaining the same functionality.

The fibre-reinforced plastic composite material can for example contain carbon fibres and/or glass fibres and/or aramid fibres and/or natural fibres. This increases the strength of the supporting element. The fibres may be in the form of short fibres and/or long fibres.

According to a preferred modification of the body arrangement the support element is designed with such a distance from the longitudinal member arrangement that in the event of a frontal collision the support element allows a predetermined deformation of the longitudinal member arrangement.

In other words, the support element is designed in such a way that it does not inhibit or restrict a deformation of the longitudinal member arrangement.

According to a further preferred design of the body arrangement according to the present invention the longitudinal member arrangement has a longitudinal support and a deformation element. The deformation element is fastened, for example releasably, to one end, in particular the front end of the longitudinal support. The bumper cross-member is fastened to the deformation element.

The deformation element may be a so-called crashbox which, in the event of low-energy collisions, in particular a frontal collision with a large overlap or full overlap at low speed, is deformable in an energy-absorbing manner, without the longitudinal support being irreversibly damaged. In this way repair costs in the event of low-speed collisions can be kept comparatively low.

According to a preferred modification of the longitudinal member arrangement with the longitudinal support and the deformation element, the support element is spaced apart from the deformation element in such a way that in the event of a frontal collision at low speed and in particular large or full overlap, at which the longitudinal support should not be damaged, the support element allows a predetermined deformation of the deformation element and the support element does not come into engagement with the longitudinal member arrangement and in particular with the longitudinal support.

A low speed is a speed less than or equal to a threshold speed value which is for example approximately 15 or 20 km/h. Moreover, it is advantageous in such an arrangement that in the event of a frontal collision with large or full overlap the support element is not damaged and does not have to be replaced. Furthermore, as the deformation of the deformation element progresses, the support element also does not engage with the longitudinal support due to the spacing and thus prevents damage to the longitudinal support by the support element.

According to a preferred modification of the body arrangement according to the invention the support element, the longitudinal member arrangement and the bumper cross-member are disposed substantially in one plane. This plane preferably extends substantially parallel to a longitudinal axis and a transverse axis of the motor vehicle or of the body.

In such an arrangement of support element, longitudinal member arrangement and bumper cross-member the co-operation thereof in the event of a frontal collision of the motor vehicle with low overlap is ensured in the best way.

The support element preferably has an inner face which extends substantially parallel to a side face of the longitudinal member arrangement, and a front face which extends substantially parallel to a rear face of the end portion of the bumper cross-member. In particular the support element can preferably have an outer face which connects the inner face and the front face to one another.

As a result the support element lies flush on the end portion of the bumper cross-member and thus can optimally transmit forces which are applied to the bumper cross-member following the collision with little overlap. Furthermore, after initial deformation of the end portion of the bumper cross-member the support element can be supported flush on the longitudinal member arrangement by the side face, which extends parallel to the longitudinal member arrangement, and in this way can introduce forces optimally into the longitudinal member arrangement.

According to a preferred modification of the support element with the inner face and the front face the support element is of substantially wedge-shaped design, wherein in particular the inner face and the outer face form a tip of the wedge.

Under the given conditions the wedge-shaped form between the end portion of the bumper cross-member and the longitudinal member arrangement is particularly suitable with regard to a transmission of forces to the longitudinal member arrangement and as a result can be of sufficiently rigid design.

The support element is preferably designed and disposed in such a way that in the event of a frontal collision with little overlap and with support on the longitudinal member arrangement the support element is not significantly deformed.

In this way after initial deformation of the end portion of the bumper cross-member the support element can introduce forces optimally into the longitudinal member arrangement and can apply a high transverse impulse to the motor vehicle, so that it is pushed away from the parties to the accident. Furthermore in this way the collision opponent is suitably prevented from moving too strongly or too far into the front part of the vehicle in the region of the front wheel arch.

The support element is preferably made of a steel material.

As a result the support element is particularly easy to produce and can have a light weight.

The support element and the longitudinal member arrangement can be designed relative to one another so that in the event of an impact of the support element on the longitudinal member arrangement following the frontal collision with little overlap an engagement between the support element and the longitudinal member arrangement takes place which prevents or at least restricts sliding of the support element on the longitudinal member arrangement.

As a result transverse impulse acting on the motor vehicle can advantageously be increased.

According to a preferred further embodiment of the body arrangement the supporting element lies flat on the end portion of the bumper cross-member and is in particular rigidly connected to the end portion of the bumper cross-member.

According to a preferred further embodiment the supporting element is formed with hollow spaces which are separated from one another by a rib structure and the extend parallel to the end portion of the bumper cross-member.

The weight of the supporting element can be reduced by the hollow spaces, wherein the rib structure ensures the necessary strength and rigidity of the supporting element. Due to the formation of the hollow spaces parallel to the end portion of the bumper cross-member the supporting element has sufficient strength and rigidity in order to transmit transverse forces to the longitudinal member arrangement in the event of a collision with little overlap.

The hollow spaces are preferably formed in pairs and separated from one another by a central rib of the rib structure.

This is advantageous with regard to the stability of the supporting element with a low weight and with regard to producibility.

The hollow spaces can be arranged one above the other and/or one behind the other.

The supporting element is preferably constructed in one piece.

The longitudinal member arrangement of the body arrangement according to the present invention may be a component of a so-called main load path in the event of a frontal collision. A main load path is the load path which in the event of collision absorbs and possibly dissipates a majority of the collision load.

A body arrangement according to the invention preferably has a left and a right longitudinal member arrangement, a left and a right support element, which are disposed in each case on a left end portion of the bumper cross-member or on a right end portion of the bumper cross-member.

Modifications of the invention set out above can be combined with one another in any way so long as it is sensible and possible.

### BRIEF DESCRIPTION OF THE DRAWING

FIG. 1 shows a schematic plan view of a body arrangement according to an exemplary embodiment of the present invention.

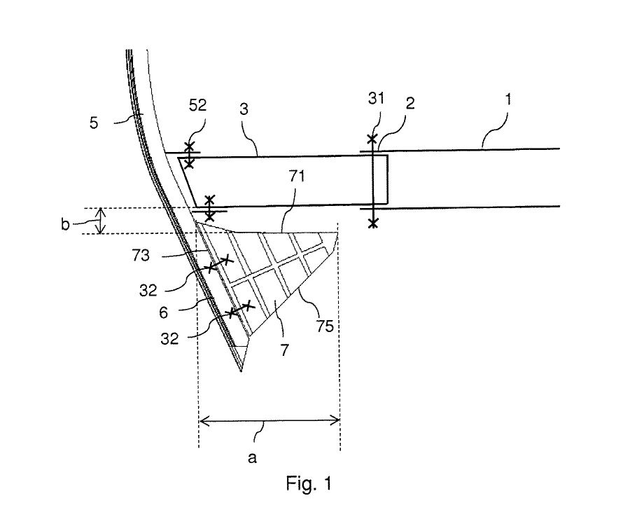

A detailed description is given below of an embodiment of the present invention with reference to FIG. 1.

A left front portion of a body arrangement of a motor vehicle is shown in FIG. 1. A right front portion (not shown) of the body arrangement is designed in mirror symmetry just like the left front portion of the body arrangement. However, in order to avoid repetitions only the left front portion of the body arrangement is described below.

In particular the body has a left longitudinal support 1, on the front end of which a crashbox 3 is disposed which constitutes a deformation element according to the invention. A bumper cross-member 5, of which the left end portion 6 projects in the transverse direction beyond the crashbox 3 or the longitudinal support 1, is fastened to the front end of the crashbox 3. A support element 7 according to the invention is fixed to the end portion 6 of the bumper cross-member 5 by fastening means 32.

The longitudinal member arrangement consisting of the longitudinal support 1 and the crashbox 3, just like the bumper cross-member 5 with the end portion 6 and the support element 7 are all disposed predominantly in a plane parallel to a longitudinal direction of the vehicle and a transverse direction of the vehicle. In this case the support element 7 is formed at a distance b with respect to the crashbox 3, wherein the support element 7 is not fixed to the longitudinal support 1 nor to the crashbox 3. The support element 7 has a maximum length a in the longitudinal direction of the vehicle.

The support element 7 is a fibre-reinforced injection moulded plastic part which is provided with a suitable reinforcing rib structure or honeycomb structure—the rib structure is shown schematically in FIG. 1—and has a substantially wedge-shaped form. The rib structure is formed in such a way that the supporting element 7 can be produced by means of second tool halves. The cells which form hollow spaces according to the invention extend parallel to the end portion 6 of the bumper cross-member 5. The cells are arranged in pairs, wherein the pairs of cells are separated from one another by a central rib. Two or more cells can be arranged one above the other. In the present exemplary embodiment two cells are arranged one above the other. Furthermore, a plurality of cells can be arranged one behind the other. In the present exemplary embodiment four cells are arranged one behind the other in the direction of travel. The cells are separated from one another by the rib structure and are open at the side. The supporting element 7 is fastened to the bumper cross-member 5 for example by two bolt connections. The bumper cross-member 5 can made from a metal material, such as for example steel or aluminium. The wedge has an inner face 71, which extends substantially parallel to the crashbox 3 or the longitudinal support 1, and a front face 73, which extends substantially parallel to the end portion 6 of the bumper cross-member 5 and bears against this in a flush manner. Furthermore the wedge has an outer face 75 which connects one end of the front face 73 to one end of the inner face 71. Basically the support element 7 may also have a different shape if it has the function described below.

The crashbox 3 is fixed releasably by means of fastening means 31 and 52, for example screws, on the longitudinal support 1 or the bumper cross-member 5. In particular, the fastening means 31 form a screw connection 31 to the longitudinal support in a transverse direction.

A mode of functioning and action of the body arrangement according to the invention is described below in the case of a frontal collision with a large overlap and a frontal collision with little overlap.

In the event of a frontal collision with a large overlap, the collision opponent impacts directly on the longitudinal member arrangement or on a location between the left and right longitudinal member arrangement.

In the event of such a frontal collision with a large overlap and at a low speed of for example less than approximately 15 or 20 km/h, preferably only the crashbox 3 is deformed, without the longitudinal support 1 being irreversibly damaged. In this case it is necessary that the crashbox 3 has sufficient space for deformation in the transverse direction, i.e. in the y-direction of a vehicle co-ordinates system, which is ensured by the spacing b between the support element 7 and the crashbox 3. In the event of a collision with a large overlap and at low speed the crashbox 3 is increasingly deformed, i.e. compressed, wherein the bumper cross-member 5 moves in the direction of the longitudinal support 1. As a result the support element 7 also moves in the direction of the longitudinal support until, if applicable, it overlaps with the longitudinal support 1 in the transverse direction of the vehicle, but due to the predetermined spacing b predominantly does not engage with the longitudinal support 1 and damage it. Accordingly due to the arrangement according to the invention the support element 7 advantageously does not restrict the functioning and action of the crashbox 3 in the event of a frontal collision with a large overlap.

In the event of a frontal collision with little overlap, in which a collision opponent impacts outside the longitudinal member arrangement on the bumper cross-member, i.e. in particular impacts only on the end portion 6 of the bumper cross-member 5, the end portion 6 of the bumper cross-member 5 is initially deformed until the inner face 71 of the support element 7 impacts on the crashbox 3 or possibly also on the longitudinal support 1 and is supported there. If need be, the inner face 71 of the support element 7 can also engage with the fastening means 31, for example screw heads, in order to prevent sliding of the inner face 71 on the longitudinal member arrangement and thus to increase the effect of the support element 7. The support element 7 is designed to be relatively rigid, so that in the collision it is not deformed or at least only slightly deformed and in this way it supports a collision load sufficiently on the longitudinal member arrangement consisting of the crashbox 3 and the longitudinal support 1 and introduces the load into the longitudinal member arrangement. As a result a transverse impulse between the motor vehicle and the collision opponent can be generated so that they can be advantageously pushed away from one another. Thus a crash structure of the motor vehicle must advantageously absorb significantly less collision energy.

1. Body arrangement for a motor vehicle, comprising
a longitudinal member arrangement (1, 3),
a bumper cross-member (5), which is fastened to one end of the longitudinal member arrangement (1, 3) and wherein one end portion (6) of the bumper cross-member (5) projects beyond the longitudinal member arrangement (1, 3) in the transverse direction, and
a support element (7), which is fastened to the end portion (6) of the bumper cross-member (5) and extends over a predetermined length (a) towards the rear in the longitudinal direction of the vehicle,
wherein the support element (7) is designed with a predetermined spacing (b) with respect to the longitudinal member arrangement (1, 3),
wherein the support element (7) is disposed and designed in such a way that it supports the end portion (6) on the longitudinal member arrangement (1, 3) in the event of a deformation of the end portion (6) of the bumper cross-member (5) following a frontal collision of the vehicle, in particular a frontal collision with little overlap.
and wherein the support element (7) is made of a plastic, in particular a fibre-reinforced plastic.

2. Body arrangement for a motor vehicle according to claim 1, wherein the support element (7) is designed with such a spacing (b) with respect to the longitudinal member arrangement (1, 3) that in the event of a frontal collision of the motor vehicle the support element (7) allows a predetermined deformation of the longitudinal member arrangement (1, 3).

3. Body arrangement for a motor vehicle according to claim 1, wherein the longitudinal member arrangement has a longitudinal support (1) and a deformation element (3) which is fastened, in particular releasably, to one end (2) of the longitudinal support (1) and is fastened to the bumper cross-member (5).

4. Body arrangement for a motor vehicle according to claim 3, wherein the support element (7) is spaced apart from the deformation element (3) in such a way that in the event of a frontal collision at low speed, at which the longitudinal support (1) should not be damaged, the support element (7) allows a predetermined deformation of the deformation element (3) and the support element does not come into engagement with the longitudinal support (1).

5. Body arrangement for a motor vehicle according to claim 1, wherein the support element (7), the longitudinal member arrangement (1, 3) and the bumper cross-member (5) are disposed substantially in a plane, in particular in a plane parallel to a longitudinal axis and a transverse axis of the motor vehicle.

6. Body arrangement for a motor vehicle according to claim 1, wherein the support element (7) has an inner face (71), which extends substantially parallel to a side face of the longitudinal member arrangement (1, 3), and a front face (73), which extends substantially parallel to the end portion (6) of the bumper cross-member (5), and wherein the support element (7) has in particular an outer face (75) which connects the inner face (71) and the front face (73) to one another.

7. Body arrangement for a motor vehicle according to claim 6, wherein the support element (7) is of substantially wedge-shaped design, wherein in particular the inner face (71) and the outer face (75) form a tip of the wedge.

8. Body arrangement for a motor vehicle according to claim 1, wherein the support element (7) is preferably designed and disposed in such a way that in the event of a frontal collision with little overlap and with support on the longitudinal member arrangement (1, 3) the support element is not significantly deformed.

9. Body arrangement for a motor vehicle according to claim 1, wherein the support element (7) is produced by plastic injection moulding.

10. Body arrangement for a motor vehicle according to claim 1, wherein the longitudinal member arrangement (1, 3) is a component of a main load path in the event of a frontal collision.

11. Body arrangement for a motor vehicle according to claim 1, wherein the support element (7) lies flat on the end portion (6) of the bumper cross-member (5) and is in particular rigidly connected to the end portion (6) of the bumper cross-member (5).

12. Body arrangement for a motor vehicle according to claim 1, wherein the supporting element (7) is formed with hollow spaces which are separated from one another by a rib structure and the extend parallel to the end portion (6) of the bumper cross-member (5).

13. Body arrangement for a motor vehicle according to claim 12, wherein the hollow spaces are formed in pairs and separated from one another by a central rib of the rib structure.

14. Body arrangement for a motor vehicle according to claim 12, wherein the hollow spaces (7) are arranged above one another and/or behind one another.

15. Body arrangement for a motor vehicle according to claim 1, wherein the support element (7) is formed in one piece.
